(19) United States
(12) Patent Application Publication
(10) Pub. No.: US 2017/0255558 A1
(43) Pub. Date: Sep. 7, 2017

(54) ISOLATION MODE IN A CACHE COHERENT SYSTEM

(71) Applicant: Arteris, Inc., Campbell, CA (US)

(72) Inventors: Craig Stephen Forrest, San Francisco, CA (US); David A. Kruckemyer, San Jose, CA (US)

(73) Assignee: Arteris, Inc., Campbell, CA (US)

(21) Appl. No.: 15/603,066

(22) Filed: May 23, 2017

Related U.S. Application Data
(63) Continuation-in-part of application No. 14/806,786, filed on Jul. 23, 2015.
(60) Provisional application No. 62/340,403, filed on May 23, 2016.

(51) Int. Cl. G06F 12/0831; G06F 12/0897; G06F 12/0817; G06F 1/32; G06F 12/0811

(52) U.S. Cl. CPC G06F 12/0831; G06F 1/3275; G06F 12/0811; G06F 12/0817; G06F 12/0897

(57) ABSTRACT

The invention involves isolating a cache coherence controller from agents or units. The term unit as used herein may refer to one or more circuits, components, registers, processors, software subroutines, or any combination thereof. The separate units communicate with each other and are logically coupled.

### CROSS REFERENCE TO RELATED APPLICATIONS

This application claim the benefit of U.S. Provisional Application Ser. No. 62/340,403 entitled ISOLATION MODE IN A CACHE COHERENT SYSTEM filed on May 23, 2016 by Craig Stephen FORREST et al. AND is a continuation-in-part of U.S. Non-Provisional application Ser. No. 14/806,786 entitled DISTRIBUTED IMPLEMENTATION FOR CACHE COHERENCE by Craig Stephen FORREST et al., the entire disclosures of which are incorporated herein by reference.

### FIELD OF THE INVENTION

The invention is in the field of cache coherent systems and, more specifically, for system-on-chip designs.

### BACKGROUND

Since computer processors with caches were first combined into multiprocessor systems there has been a need for cache coherence. More recently cache coherent multiprocessor systems have been implemented in systems-on-chips (SoCs). The cache coherent systems in SoCs comprise instances of processor intellectual properties (IPs), memory controller IPs, and cache coherent system IPs connecting the processors and memory controllers. More recently some SoCs integrate other agent IPs having coherent caches, such as graphics processing units, into heterogeneous multiprocessor systems. Such systems comprise a single centralized monolithic cache coherent system IP.

In the physical design of such SoCs, the centralized cache coherent system IP is a hub of connectivity. Use of and access to the cache coherent controller (also referred to as a cache coherence controller) includes high power consumption levels. Therefore, in order to manage power and lower power consumption, a system and method are needed to isolate some agents or units from the cache coherent controller when necessary.

### SUMMARY OF THE INVENTION

In accordance with the aspects of the invention, a system and method are disclosed that allow units to be isolated from a cache coherence controller to conserver power. The term unit as used herein may refer to one or more circuits, components, registers, processors, software subroutines, or any combination thereof. The separate units communicate with each other, and are logically coupled.

Systems that embody the invention, in accordance with the aspects thereof, are typically designed by describing their functions in hardware description languages. Therefore, the invention is also embodied in such hardware descriptions, and methods of describing systems as such hardware descriptions, but the scope of the invention is not limited thereby. Furthermore, such descriptions can be generated by computer aided design (CAD) software that allows for the configuration of coherence systems and generation of the hardware descriptions in a hardware description language. Therefore, the invention is also embodied in such software.

### BRIEF DESCRIPTION OF THE DRAWINGS

FIG. 1 illustrates the mapping of cache line sized memory address ranges to coherence controllers and memory interfaces in accordance with the various aspects of the invention.

FIG. 2 illustrates the connectivity of units in an embodiment with high connectivity in accordance with the various aspects of the invention.

FIG. 3 illustrates the connectivity of units in an embodiment that separates coherence controllers from memory interfaces in accordance with the various aspects of the invention.

FIG. 4 illustrates the connectivity of units in an embodiment that passes memory interface responses through coherence controllers in accordance with the various aspects of the invention.

FIG. 5 illustrates the connectivity of units in an embodiment that passes memory interface responses through coherence controllers with one-to-one relationships between coherence controllers and memory interfaces in accordance with the various aspects of the invention.

FIG. 6 illustrates the mapping of cache line sized memory address ranges to paired coherence controllers and memory interfaces in accordance with the various aspects of the invention.

FIG. 7 illustrates the connectivity of an embodiment with minimal connectivity in accordance with the various aspects of the invention.

FIG. 8 illustrates the process of designing a cache coherent system in accordance with the various aspects of the invention.

FIG. 9 illustrates a system comprising intermediate units within the transport network in accordance with the various aspects of the invention.

FIG. 10A illustrates a system including agents or units communicating with coherent memory and non-coherent memory in accordance with the various aspects of the invention.

FIG. 10B illustrates a system including agents or units communicating with coherent memory and non-coherent memory in accordance with the various aspects of the invention.

### DETAILED DESCRIPTION

To the extent that the terms “including”, “includes”, “having”, “has”, “with”, or variants thereof are used in either the detailed description and the claims, such terms are intended to be inclusive in a similar manner to the term “comprising”. The invention is described in accordance with the aspects and embodiments in the following description with reference to the figures, in which like numbers represent the same or similar elements. Reference throughout this specification to “one embodiment,” “an embodiment,” or similar language means that a particular feature, structure, or characteristic described in connection with the various aspects and embodiments are included in at least one embodiment of the invention. Thus, appearances of the phrases “in one embodiment,” “in an embodiment,” “in certain embodiments,” and similar language throughout this specification refer to the various aspects and embodiments of the invention. It is noted that, as used in this description, the singular forms “a,” “an” and “the” include plural referents, unless the context clearly dictates otherwise.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring the aspects of the invention.

The invention is directed to a distributed system for performing cache coherence. A cache coherence system performs at least three essential functions:
1. Interfacing to coherent agents—This function includes accepting transaction requests on behalf of a coherent agent and presenting zero, one, or more transaction responses to the coherent agent, as required. In addition, this function presents snoop requests, which operate on the coherent agent's caches to enforce coherence, and accepts snoop responses, which signal the result of the snoop requests.
2. Enforcing coherence—This function includes serializing transaction requests from coherent agents and sending snoop requests to a set of agents to perform coherence operations on copies of data in the agent caches. The set of agents may include any or all coherent agents and may be determined by a directory or snoop filter (or some other filtering function) to minimize the system bandwidth required to perform the coherence operations. This function also includes receiving snoop responses from coherent agents and providing the individual snoop responses or a summary of the snoop responses to a coherent agent as part of a transaction response.
3. Interfacing to the next level of the memory hierarchy—This function includes issuing read and write requests to a memory, such as a DRAM controller or a next-level cache, among other activities.

Performing these functions in a single unit has the benefit of keeping the logic for these related functions close together, but has several major drawbacks. The single unit will be large, and therefore will use a significant amount of silicon area. That will cause congestion in routing of wires around the unit. A single unit will also tend to favor having a single memory or, if multiple memories are used, having them close together to avoid having excessively long wires between the single coherence unit and the memories. Multiple memories, which are typically implemented with interleaved address ranges, are increasingly prevalent.

An aspect of the invention is separation of the functions of a cache coherence system into multiple distinct units, and coupling of them with a transport network. The units communicate by sending and receiving information to each other through the transport network. The units are, fundamentally:
1. Agent interface unit—This unit performs the function of interfacing to one or more agents. Agents may be fully coherent, IO-coherent, or non-coherent. The interface between an agent interface unit and its associated agent uses a protocol. The Advanced Microcontroller Bus Architecture (AMBA) Advanced eXtensible Interface (AXI) Coherency Extensions (ACE) is one such protocol. In some cases an agent may interface to more than one agent interface unit. In some such cases, each agent interface unit supports an interleaved or hashed subset of the address space for the agent.
2. Coherence controller unit—This unit performs the function of enforcing coherence among the coherent agents for a set of addresses.
3. Memory interface unit—This unit performs the function of interfacing to all or a portion of the next level of the memory hierarchy.

The transport network that couples the units is a means of communication that transfers at least all semantic information necessary, between units, to implement coherence. The transport network, in accordance with some aspects and some embodiments of the invention, is a network-on-chip, though other known means for coupling interfaces on a chip can be used and the scope of the invention is not limited thereby. The transport network provides a separation of the interfaces between the agent interface unit, coherence controller, and memory interface units such that they may be physically separated.

In addition with some aspects of the invention, a transport interconnect is a component of a system that implements functions and interfaces to allow other components to issue and receive transactions from each other. A transport interconnect is implemented by creating one or more of the following types of units:
(a). Ingress access units, which receive transactions from an external connected system component, and transmit them into the transport interconnect. Ingress units also perform access functions which may include, but are not limited to, protocol translation, transaction access semantics translation, transient transaction storage and re-ordering, splitting external access transactions into multiple internal transport interconnect transactions and merging multiple external access transactions into single internal transport interconnect transactions.
(b). Egress access units, which receive transactions from the transport interconnect, and transmit them to an external connected system component. Egress units also perform access functions which may include, but are not limited to, protocol translation, transaction access semantics translation, transient transaction storage and re-ordering, splitting internal transport transactions into multiple external access transactions and merging multiple internal transport transactions into single external access transactions.
(c). Link units, which have a single input connection and a single output connection. Link unit's primary function is to transport a transaction from the input connector to the output connector without reformatting or in any other way changing the transaction from its path from the input connector to the output connector. Typically, a link is simply a set of wires, but in some cases, it may be a pipelined datapath where transactions may take a number of clock cycles to travel from the input connect to the output connector.
(d). Switching units, which have one or more independent input connections and one or independent output connections. Each transaction that is received on an input connection is forwarded to an output connection. The specific output connection is selected by examining the incoming transaction. In some cases the output port is explicitly named within the incoming transaction. In other cases, the output port is selected via algorithms implemented in the switch. Switching units may implement arbitration algorithms in order to ensure that transactions from input connections are forwarded output connections so as to satisfy the system requirements for transaction prioritization and starvation avoidance. Additionally, switch units may implement other functionality that may include, but is not limited to, security functions, logging transactions, tracing transactions, voltage domain management, clock domain management, bandwidth adaptation, traffic shaping, transient transaction storage, clock domain crossing and voltage domain crossing.

An interconnect transport is built by creating and connecting multiple units, of each type. Ingress units are connected to input connectors of link units or switch units. Egress units are connected to output connectors of link units or switch units. In addition, the input connection of a link unit connects to an output connection of a switch (or an Ingress unit), and the output connection of a link unit connects to an input connection of a switch (or an Egress unit).

A transport network, according to some embodiments of the invention, is packet-based. In some embodiments, it may support read requests, or write requests or both read and write requests, and issues a response to each request. In other embodiments, it may support read requests, or write requests or both read and write requests, and will not issue a response, or any other form of positive acknowledgment to every request. In other embodiments, the transport network is message-based. In some embodiments multi-party transactions are used such that initiating agent requests go to a coherence controller, which in turn forwards requests to other caching agents, and in some cases a memory, and the agents or memory send responses directly to the initiating requestor. In some embodiments, the transport network supports multicast requests such that a coherence controller can, as a single request, address some or all of the agents and memory. According to some embodiments the transport network is dedicated to coherence-related communication and in other embodiments at least some parts of the transport network are used to communicate non-coherent traffic. In some embodiments the transport interconnect is a network-on-chip. In other embodiments, the transport interconnect has a switch topology of a grid-based mesh or depleted-mesh. In other embodiments a network interconnect has a topology of switches of varied sizes. In some embodiments the transport interconnect implements a switch topology of a crossbar. In some embodiments, a network-on-chip uses virtual channels.

According to another aspect of the invention, each type of unit can be implemented as multiple separate instances. A typical system has one agent interface unit associated with each agent, one memory interface unit associated with each of a number of main memory storage elements, and some number of coherence controllers, each responsible for a portion of a memory address space in the system.

In accordance with some aspects of the invention, there does not need to be a fixed relationship between the number of instances of any type and any other type of unit in the system. A typical system has more agent interface units than memory interface units, and a number of coherence controllers that is in a range close to the number of memory interface units. In general, a large number of coherent agents in a system, and therefore a large number of agent interface units implies large transaction and data bandwidth requirements, and therefore requires a large number of coherence controllers to receive and process coherence commands and to issue snoop requests in parallel, and a large number of memory interface units to process memory command transactions in parallel.

Separation of coherence functions into functional units and replication of instances of functional units according to the invention provides for systems of much greater bandwidth, and therefore a larger number of agents and memory interfaces than is efficiently possible with a monolithic unit. This is, in part, because providing sufficient bandwidth from a monolithic coherence unit to a large number of physically distributed agents would cause a centralized point with a number of wires that is too large to efficiently route and require an intolerably high amount of power. A high amount of power consumption density in a centralized point creates problems for heat dissipation, manufacturability, and reliability.

The invention can be embodied in a physical separation of logic gates into different regions of a chip floorplan. The actual placement of the gates of individual, physically separate units might be partially mixed, depending on the floorplan layout of the chip, but the invention is embodied in a chip in which a substantial bulk of the gates of each of a plurality of units is noticeably distinct within the chip floorplan.

The invention can be embodied in a logical separation of functionality into units. Units for agent interface units, coherence controller units, and memory interface units may have direct point-to-point interfaces. Alternatively, communication between units may be performed through a communication hub unit.

The invention, particularly in terms of its aspect of separation of function into units, is embodied in systems with different divisions of functionality. The invention can be embodied in a system where the functionality of one or more of the agent interface units, coherence controller units, and memory interface units are divided into sub-units, e.g. a coherence controller unit may be divided into a request serialization sub-unit and a snoop filter sub-unit. The invention can be embodied in a system where the functionality is combined into fewer types of units, e.g. the functionality from a coherence controller unit can be combined with the functionality of a memory interface unit. The invention can be embodied in a system of arbitrary divisions and combinations of sub-units.

Some embodiments of a cache coherent system according to the invention have certain functionality between an agent and its agent interface unit. The functionality separates coherent and non-coherent transactions. Non-coherent transactions are requested on an interface that is not part of the cache coherent system, and only coherent transactions are passed to the agent interface unit for communication to coherence controller units. In some embodiments, the function of separating coherent and non-coherent transactions is present within the agent interface unit.

In accordance with some aspects and some embodiments of the invention, one or more agent interface units communicate with IO-coherent agents, which themselves have no coherent caches, but require the ability to read and update memory in a manner that is coherent with respect to other coherent agents in the system using a direct means such as transaction type or attribute signaling to indicate that a transaction is coherent. In some aspects and embodiments, one or more agent interface units communicate with non-coherent agents, which themselves have no coherent caches, but require the ability to read and update memory that is coherent with respect to other coherent agents in the system using an indirect means such as address aliasing to indicate that a transaction is coherent. For both IO-coherent and non-coherent agents, the coupled agent interface units provide the ability for those agents to read and update memory in a manner that is coherent with respect to coherent agents in the system. By doing so, the agent interface units act as a bridge between non-coherent and coherent views of memory. Some IO-coherent and non-coherent agent interface units may include coherent caches on behalf of their agents. In some embodiments, a plurality of agents communicate with an agent interface unit by aggregating their traffic via a multiplexer, transport network or other means. In doing so, the agent interface unit provides the ability for the plurality of agents to read and update memory in a manner that is coherent with respect to coherent agents in the system. In some aspects and embodiments, different agent interface units communicate with their agents using different transaction protocols and adapt the different transaction protocols to a common transport protocol in order to carry all necessary semantics for all agents without exposing the particulars of each agent's interface protocol to other units within the system. Furthermore, in accordance with some aspects as captured in some embodiments, different agent interface units interact with their agents according to different cache coherence models, while adapting to a common model within the coherence system. By so doing, the agent interface unit is a translator that enables a system of heterogeneous caching agents to interact coherently.

In accordance with some aspects of the invention, some embodiments include more than one coherence controller, each coherence controller is responsible for a specific part of the address space, which may be contiguous, non-contiguous or a combination of both. The transport network routes transaction information to a particular coherence controller as directed by sending units. In some embodiments, the choice of coherence controller is done based on address bits above the address bits that index into a cache line, so that the address space is interleaved with such a granularity that sequential cache line transaction requests to the agent interface unit are sent to alternating coherence controllers. Other granularities are possible.

In other embodiments that capture other aspects of the invention, the choice of coherence controller to receive the requests is determined by applying a mathematical function to the address. This function is known as a hashing function. In accordance with some aspects and some embodiments of the invention, the hashing function causes transactions to be sent to a number of coherence controllers that is not a power of two. The association of individual cache line addresses in the address space to coherence controllers can be any arbitrary assignment; provided there is a one-to-one association of each cache-line address to a specific coherence controller.

According to some aspects and embodiments, coherence controllers perform multiple system functions beyond receiving transaction requests and snoop responses and sending snoop requests, memory transactions, and transaction responses. Some such other functions include snoop filtering, exclusive access monitors, and support for distributed virtual memory transactions.

In accordance with some aspects, embodiments that comprise more than one memory interface unit, each memory interface unit is responsible for a certain part of the address space, which may be contiguous, non-contiguous or a combination of both. For each read or write that requires access to memory, the coherence controller (or in some embodiments, also the agent interface unit) determines which memory interface unit from which to request the. In some embodiments the function is a simple decoding of address bits above the address bits that index into a cache line, but it can be any function, including ones that support numbers of memory interface units that are not powers of two. The association of individual cache line addresses in the address space to memory interface units can be any arbitrary assignment; provided there is a one-to-one association of individual cache-line addresses to specific memory interface units.

In some embodiments, agent interface units may have a direct path through the transport network to memory interface units for non-coherent transactions. Data from such transactions may be cacheable in an agent, in an agent interface unit, or in a memory interface unit. Such data may also be cacheable in a system cache or memory cache that is external to the cache coherence system.

The approach to chip design of logical and physical separation of the functions of agent interface, coherence controller, and memory interface enables independent scaling of the multiplicity of each function from one chip design to another. That includes both logical scaling and physical scaling. This allows a single semiconductor IP product line of configurable units to serve the needs of different chips within a family, such as a line of mobile application processor chips comprising one model with a single DRAM channel and another model with two DRAM channels or a line of internet communications chips comprising models supporting different numbers of Ethernet ports. Furthermore, such a design approach allows a single semiconductor IP product line of configurable units to serve the needs of chips in a broad range of application spaces, such as simple consumer devices as well as massively parallel multiprocessors.

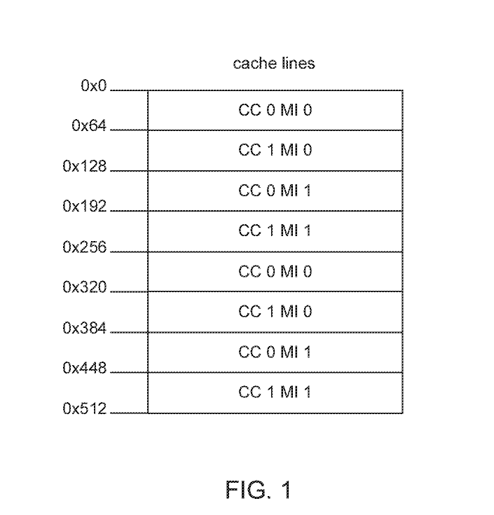

Referring now to FIG. 1, in accordance with various aspects of the invention, a memory address map for an embodiment with two coherence controllers and two memory interfaces is shown. Different embodiments may have different cache line sizes. In this embodiment, each cache line consists of 64 bytes. Therefore, address bits 6 and above choose a cache line. In accordance with some aspects of the invention and this embodiment, each cache line address range is mapped to an alternating coherence controller. Alternating ranges of two cache lines are mapped to different memory interfaces. Therefore, requests for addresses from 0x0 to 0x3F go to coherence controller (CC) 0 and addresses from 0x40 to 0x7F go to CC 1. If either of those coherence controllers fails to find the requested line in a coherent cache, a request for the line is sent to memory interface (MI) 0. Likewise, requests for addresses from 0x80 to 0xBF go to CC 0 and addresses from 0xC0 to 0xFF go to CC 1. If either of those coherence controllers fails to find the requested line in a coherent cache, a request for the line is sent to MI 1.

The ranges of values provided above do not limit the scope of the present invention. It is understood that each intervening value, between the upper and lower limit of that range and any other stated or intervening value in that stated range, is encompassed within the scope of the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

In accordance with various aspects and some embodiments of the invention, the address hashing function for coherence controllers and the address hashing function for memory interface units is the same. In such a case, there is necessarily a one-to-one relationship between the presence of coherence controllers and memory interface units, and each coherence controller is effectively exclusively paired with a memory interface unit. Such pairing can be advantageous for some system physical layouts, though does not require a direct attachment or any particular physical location of memory interface units relative to coherence controllers. In some embodiments the hashing functions for coherence controllers are different from that of memory interface units, but the hashing is such that a cache coherence controller unit is exclusively paired with a set of memory interface units or such that a number of coherence controllers are exclusively paired with a memory interface unit. For example, if there is 2-way interleaving to coherence controller units and 4-way interleaving to memory interface units, such that pairs of memory interface units each never get traffic from one coherence controller unit, then there are two separate hashing functions, but exclusive pairing.

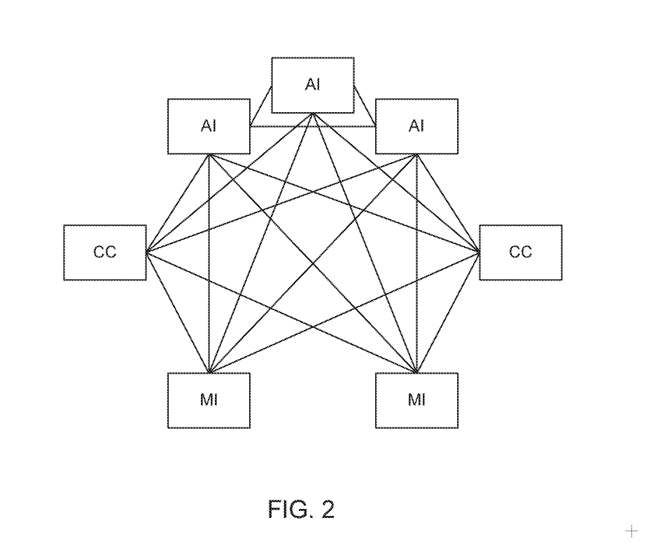

Referring now to FIG. 2, in accordance with various aspects and some embodiments of the invention, logical connectivity exists between all units, except for connectivity between coherence controllers and except for connectivity between memory interface units. This high degree of connectivity may be advantageous in some systems for minimizing latency. Such a configuration, with three agent interface (AI) units, two coherence controllers (CC), and two memory interface (MI) units is shown in FIG. 2. In such a configuration, one possible method of operation for a read memory request is as follows:
1. Agent interface units send read requests to coherence controllers.
2. Coherence controllers send snoops to as many agent interface units as necessary.
3. Agent interface units snoop their agents and send snoop responses to coherence controllers and, if the cache line is present in the agent cache, send the cache line to the requesting agent interface unit.
4. If a requested cache line is not found in an agent cache then the coherence controller sends a request to the memory interface unit.
5. The memory interface unit accesses memory, and responds directly to the requesting agent interface unit.

A possible method of operation for a write memory request is as follows:
1. Agent interface units send write requests to coherence controllers.
2. Coherence controllers send snoops to as many agent interface units as necessary.
3. Agent interface units snoop their agents and cause evictions and write accesses to memory or, alternatively, forwarding of data to the requesting agent interface unit.

In some embodiments data writes are issued from a requesting agent interface unit directly to destination memory interface units. The agent interface unit is aware of the address interleaving of multiple memory interface units. In alternative embodiments, data writes are issued before, simultaneously with, or after coherent write commands are issued to coherence controllers. In some embodiments the requesting agent interface unit receives cache lines from other AIUs, and merges cache line data with the data from its agent before issuing cache line writes to memory interface units.

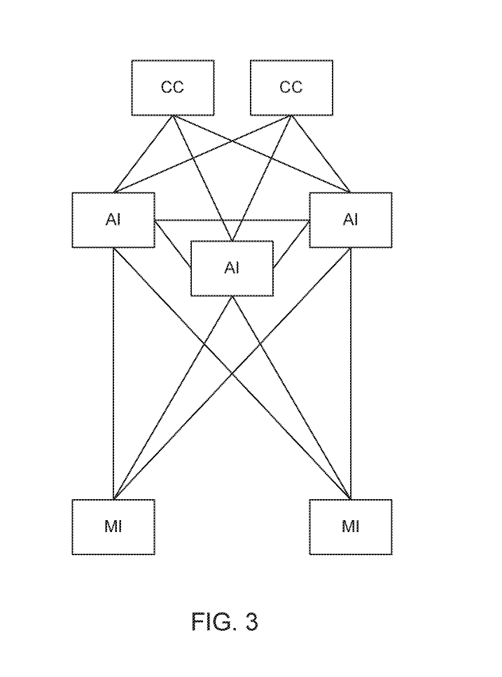

Referring now to FIG. 3, other embodiments may have advantages in physical layout by having less connectivity. In accordance with various aspects and some embodiments of the invention, the connectivity of which is shown in FIG. 3, there is no connectivity between coherence controllers and memory interfaces. Such an embodiment requires that step 4 above be expanded so that if the requested line is not found in an agent cache, the coherence controller responds as such to the requesting agent interface unit, which then initiates a request to an appropriate memory interface unit.

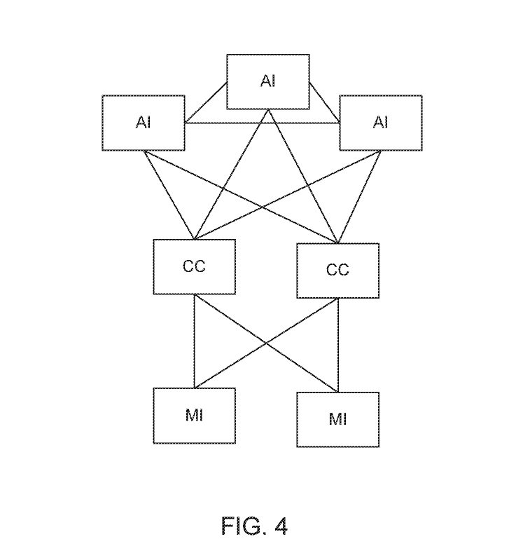

Referring now to FIG. 4, in accordance with various aspects of the invention, the connectivity of another embodiment is shown. In this configuration step 5 is changed so that memory interface units respond to coherence controllers, which in turn respond to agent interface units.

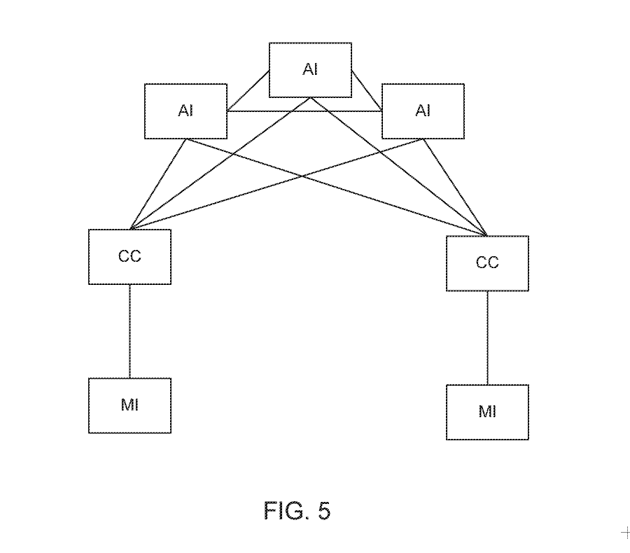

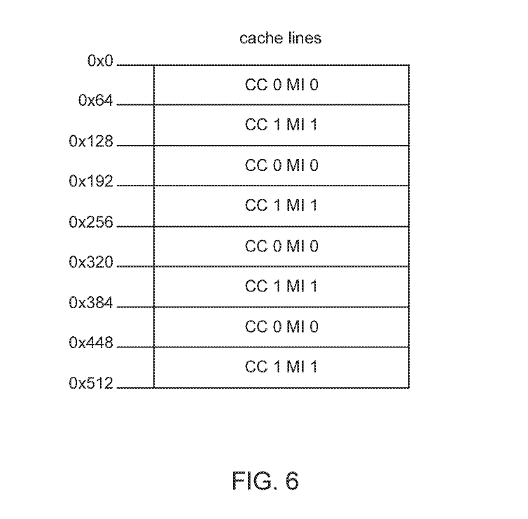

Referring now to FIG. 5 and FIG. 6, In accordance with various aspects of the invention, shown is the connectivity of a similar embodiment, but with a one-to-one pairing between coherence controllers and memory interface units such that each need have no connectivity to other counterpart units. Unlike the memory map of FIG. 1, interleaving of cache lines must be per paired coherence controller and memory interface, as shown in FIG. 6. Such a mapping of cache lines to coherence controller units and memory interface units is also valid for embodiments as shown in FIG. 2 and FIG. 3.

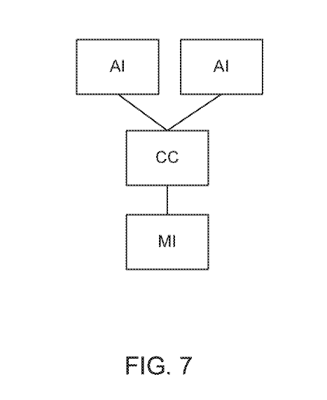

Referring now to FIG. 7, in accordance with various aspects and some embodiments of the invention, the connectivity of a very basic configuration is shown. Each agent interface unit is coupled exclusively with a single coherence controller, which is coupled with a single memory interface unit. Step 3 is modified so that the responding agent interface unit only responds with cache lines to the coherence controller, which forwards the cache lines to the requesting agent. Step 5 is modified in that any need for memory access only occurs strictly between the coherence controller and memory interface unit.

The physical implementation of the transport network topology is an implementation choice, and need not directly correspond to the logical connectivity. The transport network can be, and typically is, configured based on the physical layout of the system. Various embodiments have different multiplexing of links to and from units into shared links and different topologies of network switches.

System-on-chip (SoC) designs can embody cache coherence systems according to the invention. Such SoCs are designed using models written as code in a hardware description language. A cache coherent system and the units that it comprises, according to the invention, can be embodied by a description in hardware description language code stored in a non-transitory computer readable medium.

Many SoC designers use software tools to configure the coherence system and its transport network and generate such hardware descriptions. Such software runs on a computer, or more than one computer in communication with each other, such as through the Internet or a private network. Such software is embodied as code that, when executed by one or more computers causes a computer to generate the hardware description in register transfer level (RTL) language code, the code being stored in a non-transitory computer-readable medium. Coherence system configuration software provides the user a way to configure the number of agent interface units, coherence controllers, and memory interface units; as well as features of each of those units. Some embodiments also allow the user to configure the network topology and other aspects of the transport network. Some embodiments use algorithms, such as ones that use graph theory and formal proofs, to generate a topology network.

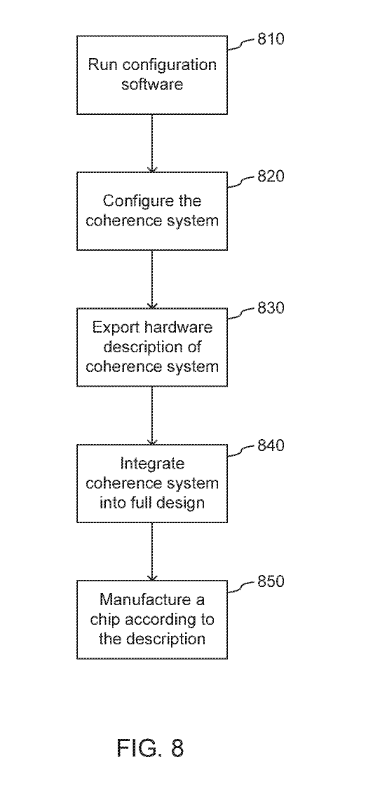

Referring now to FIG. 8, in accordance with various aspects and some embodiments of the invention, a process for designing a coherence system using configuration software is shown. The process includes, at step 810, running the configuration software. At step 820, a designer uses the software to configure a coherence system. This involves, at least, declaring a number of agent interface units, declaring a number of coherence controllers, and declaring a number of memory interface units. At step 830, the process uses software to generate and export a description of the coherence system in a hardware description language, such as Verilog. At step 840, integrating the coherence system hardware description with other parts of the chip design. At step 850, performing the usual steps for manufacturing a chip that comprises the behavioral functionality described by the hardware description language. Some typical steps for manufacturing chips from hardware description language descriptions include verification, synthesis, place & route, tape-out, mask creation, photolithography, wafer production, and packaging. As will be apparent to those of skill in the art upon reading this disclosure, each of the aspects described and illustrated herein has discrete components and features, which may be readily separated from or combined with the features and aspects to form embodiments, without departing from the scope or spirit of the invention. Any recited method can be carried out in the order of events recited or in any other order which is logically possible.

Another benefit of the separation of functional units, according to the invention, is that intermediate units can be used for monitoring and controlling a system. For example, some embodiments of the invention include a probe unit within the transport network between one or more agent interface units and the other units to which it is coupled. Different embodiments of probes perform different functions, such as monitoring bandwidth and counting events. Probes can be placed at any point in the transport network topology.

Some embodiments of the invention include a firewall unit in the transport topology. A firewall unit moots transaction requests with certain characteristics, such as a particular address range or a particular target unit.

Some embodiments of the invention include a buffer in the transport topology. A buffer can store a number of requests or responses in transit between functional units. One type of a buffer is a FIFO. Another type of buffer is a rate adapter, which stores partial data bursts.

Some embodiments of the invention include a domain adapter in the transport topology. One type of domain adapter is a clock domain adapter, which enables communication between functional units in different clock domains. Another type of domain adapter is a power disconnect unit, which enables functional units in one domain to be powered down while functional units in other domains continue to operate.

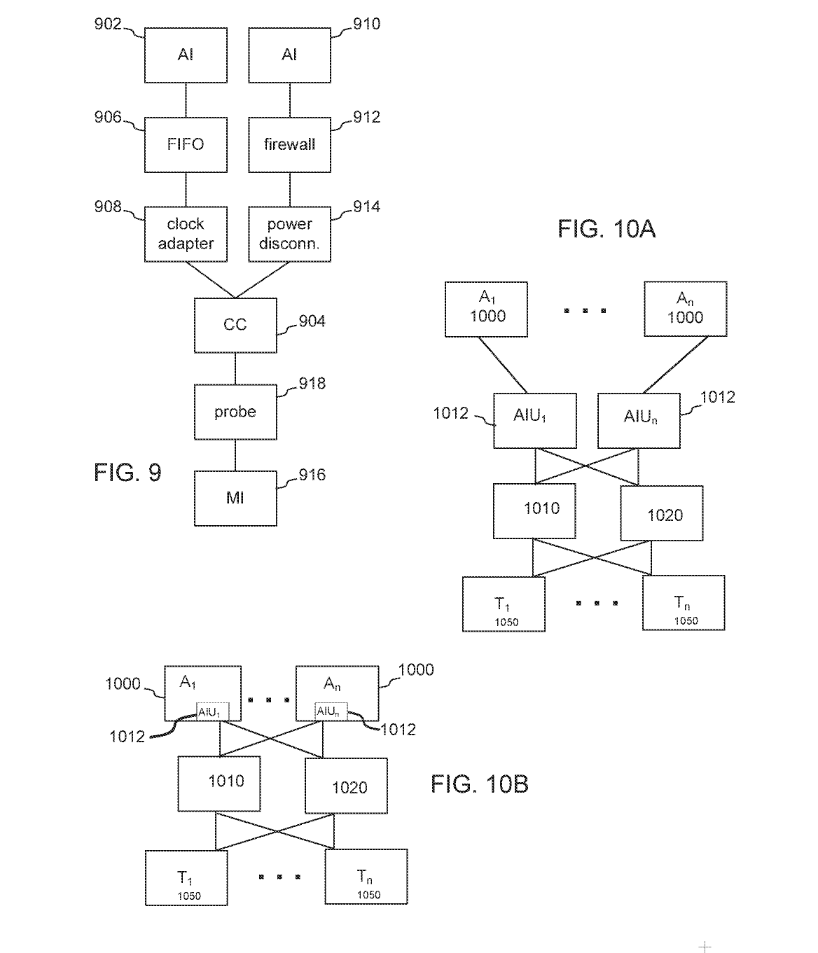

FIG. 9 shows a system according to the invention. Agent interface 902 is coupled to coherence controller 904 through FIFO buffer 906 and clock domain adapter 908. Agent interface 904 is coupled to coherence controller 904 through firewall 912 and power disconnect 914. Coherence controller 904 is coupled to memory interface 916 through probe 918.

In accordance with various aspects of the invention, resources used in a coherent system can be preserved or demands on resources can be reduced by isolating an agent from the coherent controller. For example, an agent's AIU also implements an Agent Isolation Enable (AIE) bit that controls the translation of native agent coherent transactions into protocol transactions. If the AIE bit is set, all native agent coherent transactions are translated into native agent non-coherent transactions or are terminated within the associated AIU. Alternatively, if the AIE bit is clear, all native agent coherent transactions are processed normally. In the event the AIE bit is set, then the agent can be isolated from the coherent controller.

Referring now to FIGS. 10A and 10B, a system is shown with agents A₁ through Aₙ 1000 including agent interface units (AIU₁ through AIUₙ) 1012 for each of the agents A₁ through Aₙ 1000, respectively. In FIG. 10A, the AIUs are shown as separate blocks from their respective agents for purpose of simplicity and discussion of the functions. In FIG. 10B the AIUs are shown as blocks that are part of the agents for purpose of simplicity and discussion of the functions. The system includes a coherent memory with cache coherent controller 1010, and a non-coherent memory with non-coherent controller 1020. The agent A1 1000 is in communication with the coherent controller 1010 and the non-coherent controller 1020. The AIU₁ through AIUₙ 1012, each independently, can isolate its agent (A₁ through Aₙ, respectively) from the cache coherent controller 1010 from the agent A1 1000. The coherent memory with cache coherent controller 1010 and the non-coherent memory with non-coherent controller 1020 communicate with targets T₁ through Tₙ 1050.

In order to transition the agent's AIU to the offline state and isolate it from the coherent controller, some requests have to been satisfied, as follows:
All outstanding native agent coherent transactions that can allocate data into the agent's cache must be completed;
The agent's cache must be cleaned and invalidate; and
All remaining outstanding native agent coherent transactions must be completed.

Additional native agent coherent transactions must not be performed. If a Bridge AIU is configured with an IO cache, the IO cache must be offline. Once the prerequisites have been satisfied, PMSW performs the following steps to complete the transition to offline state:
1. In each directory unit, clear the Caching Agent Snoop Enable bit (Caching Agent Snoop Enable Register) for the caching agent, if appropriate.
2. Clear the ACE DVM Snoop Enable bit (ACE DVM Snoop Enable Register) for the AIU, if appropriate.
3. In each directory unit, poll the Caching Agent Snoop Active bit (Caching Agent Snoop Activity Register) for the caching agent until clear, if appropriate.
4. Poll the ACE DVM Snoop Active bit (ACE DVM Snoop Activity Register) for the AIU until clear, if appropriate.
5. Poll the Snoop Transaction Active bit (Transaction Activity Register) in the AIU until clear.

An AIU that is offline may still perform native agent non-coherent transactions and may map native agent coherent transactions into non-coherent transactions (see Transition to Isolated below). Before gating the AIU core logic clock and before lowering the AIU core logic supply voltage, if desired, PMSW must ensure that the associated agent cannot initiate any activity that requires the AIU core logic.

The prerequisites for transitioning an AIU to the isolated state are outline below in accordance with some aspects of the invention. Once the prerequisites have been satisfied, PMSW performs the following steps to complete the transition to isolated state:
1. Perform the steps required to transition the AIU to the offline state, ignoring the prerequisites; in other words, stopping coherent transactions from the agent or flushing the agent's caches is not required.
2. Set the Agent Isolation Enable bit (Transaction Control Register) for the AIU.

Once the AIU is in the isolated state, the agent may begin executing coherent transactions and allocating data into its cache. The AIU will map certain coherent transactions into non-coherent transactions and will terminate other coherent transactions locally, effectively isolating the agent from the coherent subsystem. Before transitioning to the online state from the isolated state, the AIU must first transition to the offline state, including cleaning and invalidating the agent's caches.

The prerequisites for transitioning an AIU to the online state follow:
The AIU core logic clock must be running;
The AIU core logic supply voltage must be raised to an operational level; and
An AIU core logic reset sequence must be performed if the supply voltage was below the retention level.

Once the prerequisites have been satisfied, PMSW performs the following steps to complete the transition to online state:
1. In each directory unit, set the Caching Agent Snoop Enable bit (Caching Agent Snoop Control Register) for the AIU, if appropriate.
2. Set the DVM Agent Snoop Enable bit (ACE DVM Snoop Control Register) for the AIU, if appropriate.

Once an AIU is online, the associated agent may begin to issue native agent coherent transactions to implement an agent isolation mode. The native interface layer can be programmed by software to isolate the ACE AIU and its associated agent from the coherence domain in a state known as agent isolation mode. This mode is typically enabled during extreme low power states when the coherence domain is in the offline state, but the mode may be enabled anytime software wishes to prevent transactions issued by the agent from accessing coherence domain resources.

The system requirements for transitioning an AIU to the isolated state are described in the Concerto System Architecture Specification. In particular, all outstanding snoops to the isolated agent must be completed, and new snoops must not be issued to the isolated agent. When the agent isolation mode control bit transitions from clear to set, the AIU stalls any new transactions on the AR and AW channels until the following conditions occur:
For each CMDreq message issued, a corresponding CMDrsp message has been received;
For each DTWreq message issued from the OTT, a corresponding DTWrsp message has been received;
For each UPDreq message issued, a corresponding UPDrsp message has been received;
For each SNPreq message received, a corresponding SNPrsp message has been issued;
For each STRreq message received, a corresponding STRrsp message has been issued;
For each DTRreq message received, a corresponding DTRrsp message has been issued; and
All OTT resources have been deallocated.

The above should be covered when all CMD credits are available, all OTT resources are free, and the SFI slave response FIFO is empty. Once these conditions have been met, the AIU begins processing native agent transactions on the AR and AW channels. At this point, the AIU translates certain ACE coherent transactions into non-coherent transactions or terminates the ACE coherent transactions internally. The following sections describe the details of the translation or termination.

Read Transactions: A ReadOnce, ReadShared, ReadClean, ReadNotSharedDirty, or ReadUnique transaction is translated into a ReadNoSnoop transaction and is issued to the AXI transport layer. Each read transaction is completed as a ReadNoSnoop transaction.

Clean and Make Transactions: A CleanUnique, MakeUnique, CleanShared, CleanInvalid, or MakeInvalid transaction is allocated an OTT-Ctrl resource in a state ready to issue the native agent response. In all cases, the coherence result {SS, SO, SD, ST} is assumed to be {0, 0, 0, 0}, and upon receiving the RACK signal from the agent, the AIU suppresses issuing the STRrsp message and deallocates the OTT-Ctrl resource. In the case of a CleanUnique with the ARLOCK signal asserted, the AIU assumes the AceExOkay bit is asserted and returns and EXOKAY response.

Write Transactions: A WriteUnique, WriteLineUnique, WriteClean, or WriteBack transaction is translated into a WriteNoSnoop transaction and is issued to the AXI transport layer. Each write transaction is completed as a WriteNoSnoop transaction.

Evict Transactions: An Evict or WriteEvict transaction is allocated an OTT-Ctrl resource in a state ready to issue the native agent response. Upon receiving the WACK signal from the agent, the AIU deallocates the OTT-Ctrl resource.

DVM Transactions: A DVM operation or DVM sync transaction is allocated an OTT-Ctrl resource in a state ready to issue the native agent response. Upon receiving the RACK signal from the agent, the AIU deallocates the OTT-Ctrl resource. In the case of a DVM sync transaction, the AIU also issues the DVM completion transaction on the AC channel of the agent.

Unless defined otherwise, all technical and scientific terms used herein have the same meaning as commonly understood by one of ordinary skill in the art to which this invention belongs. The verb couple, its gerundial forms, and other variants, should be understood to refer to either direct connections or operative manners of interaction between elements of the invention through one or more intermediating elements, whether or not any such intermediating element is recited. Any methods and materials similar or equivalent to those described herein can also be used in the practice of the invention. Representative illustrative methods and materials are also described.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein.

In accordance with the teaching of the invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

The scope of the invention, therefore, is not intended to be limited to the various aspects and embodiments discussed and described herein. Rather, the scope and spirit of invention is embodied by the appended claims.

What is claimed is:

1. A system-on-chip (SoC) with cache coherence, the SoC comprising:
a plurality of units, each including an agent interface, distributed within the SoC's floorplan;
coherent memory, including a cache coherent controller, in communication with each of the plurality of units; and
non-coherent memory in communication with each of the plurality of units,
wherein a first plurality of units, using the agent interface of each of the first plurality of units, are isolated from the cache coherent controller, such that when the cache coherent controller is isolated from the first plurality of units there no communication between the cache coherent controller and the cache coherent controller communicates with a second plurality of units to at least reduce power consumption,
wherein the first plurality of units and the second plurality of units collectively represent all of the plurality of units.

2. A method of reducing power consumption in system-on-chip (SoC) with cache coherence, the method comprising:
distributing a plurality of units, each including an agent interface, within a floorplan of the SoC;
communicating between a coherent memory, including a cache coherent controller, and each of the plurality of units;
communicating between non-coherent memory and each of the plurality of units;
isolating a first plurality of units from the cache coherent controller and allowing communication between a second plurality of units and the cache coherent controller,
wherein the first plurality of units and the second plurality of units collectively represent all of the plurality of units.

3. A system comprising:
a plurality of agents, each including an agent interface, distributed within the system;
coherent memory, including a cache coherent controller, the coherent memory being in communication with each of the plurality of agents through the cache coherent controller; and
non-coherent memory in communication with each of the plurality of agents through the agent interface of each of the plurality of agents,
wherein the coherent memory communicates with a second plurality of agents,
wherein at least one agent, using the agent interface of the at least one agent, is isolated from the coherent memory, such that when the coherent memory is isolated from the at least one agent there no communication between the cache coherent controller and the at agent interface of the least one agent thereby at least reducing the system's power consumption,
wherein the at least one agent and the second plurality of agents collectively represent all of the plurality of agents.
